(19) United States
(12) Patent Application Publication
(10) Pub. No.: US 2010/0021861 A1
(43) Pub. Date: Jan. 28, 2010

(54) Tooth grinding system

(76) Inventors: Charles C. Maker, Carbondale, CO (US); John L. Raudat, Kalispell, MT (US)

Correspondence Address: Joseph S. Iandiorio;INTELLECTUAL PROPERTY LAW ATTORNEYS, 260 Bear Hill Road, Waltham, MA, 02451-1018, US

(21) Appl. No.: 12/386,230

(22) Filed: Apr. 15, 2009

Related U.S. Application Data
(60) Provisional application No. 61/045,486, filed on Apr. 16, 2008.

(51) Int. Cl. A61D 5/00; A61C 3/06

(52) U.S. Cl. 433/125

(57) ABSTRACT

A tooth grinding system includes an electric motor, a drive unit driven by the motor, a float arm attached to the electric motor at one end, a cutter head at the distal end of the arm including a drive assembly and a cutter element driven by the drive assembly and a flexible drive member within the arm and driven by the drive unit to drive the drive assembly and cutter element.

### RELATED APPLICATIONS

This application claims benefit of and priority to U.S. Provisional Application Ser. No. 61/045,486 filed Apr. 16, 2008 under 35 U.S.C. §§119, 120, 363, 365, and 37 C.F.R. §1.55 and §1.78 incorporated herein by this reference.

### FIELD OF THE INVENTION

This invention relates to a tooth grinding system and more particularly to such a tooth grinding system for equine use.

### BACKGROUND OF THE INVENTION

Horses develop sharp points on their teeth from uneven wearing or natural tooth growth. A horse's upper and lower jaws may not align perfectly, leaving the overhanging sides of the teeth to grow out into sharp edges. The back molars can also cut the horse's cheek or tongue if left untreated, resulting in pain when the animal is chewing or being ridden. Further, the use of a bit in a horse's mouth can often cause damage to the teeth. For these reasons, horses need to have their teeth floated periodically.

“Floating” is the process of gently filing sharp edges on the teeth down with a tool such as a long-handled dental rasp. The instrument utilized to file the teeth of a horse is commonly referred to as a “float.” Typically a veterinarian will use a file or float to grind down the spikes or sharp edges, which can be an awkward and tiring procedure. The veterinarian must keep the horse's mouth open while maneuvering the tool within the mouth. Very often the spike or sharp edge is near the back of the horse's mouth and it can be very difficult to reach into the depths of the mouth and still do an effective job without damaging the interior walls of the mouth. Numerous float designs have been proposed, from a simple rasp to a float with a head of carbide grit, similar to sandpaper, and an attached electric motor.

U.S. Pat. Nos. 6,273,712 and 7,101,176 describe two examples of float designs. Each device features an elongated hollow tube that carries a drive shaft driven by a “pistol-grip” style electric motor. At one end of the drive shaft is a grinding surface that is inserted into the mouth of the animal. However, prior art devices suffer from a number of deficiencies, such as, for example, a gearbox located within the cutting head which effect the right angle term necessary to properly orient the cutting head to the horses teeth. Such an arrangement has typically been required to provide enough power to the cutting head, but this also increases the size of the cutting head, and thus the ability to maneuver the tool in the animal's mouth. Lubricants must also be added to the gearbox, which can result in the contamination of the mouth of the animal being floated. In addition, prior art devices feature complex gear arrangements that require extensive maintenance and are difficult to rebuild when they fail. Thus, devices described in the prior art suffer from several shortcomings that render the grinding of a horse's teeth a laborious, unsafe, and unsanitary endeavor.

### SUMMARY OF THE INVENTION

In accordance with various aspects of the subject invention in at least one embodiment the invention presents an improved tooth grinding system for floating, for example horse teeth, which eliminates the need for a right angle gear change in the cutter head, which reduces the size and height of the cutter head, can be easily disassembled and repaired for self service, can comfortably be applied further back in the horse's mouth, is quieter and less likely to alarm the horse and uses a drive which provides the right angle change of direction not at the cutter head but back at the motor resulting in an easier grip for the user and even allows the motor portion to be rested on the users shoulder. A further advantage is that the operative parts in the cutter head can be simply and easily replaced without special skills or tools or referral to the factory or service centers.

The subject invention results from the realization, in part, that an improved tooth grinding system in various aspects can be achieved by the use of an electric motor which provides the drive through initial right angle gearing at the motor to power a first drive unit which through a flexible drive element drives a drive assembly in the cutter head so that that drive unit and drive assembly have generally parallel axes of rotation and the need for a gear box in the cutter head is eliminated.

The subject invention, however, in other embodiments, need not achieve all these objectives and the claims hereof should not be limited to structures or methods capable of achieving these objectives.

This invention features a tooth grinding system including an electric motor, a drive unit driven by the motor, and a float arm attached to the electric motor at one end. A cutter head at the distal end of the arm includes a drive assembly and a cutter element driven by the drive assembly and a flexible drive member within the arm is driven by the drive unit to drive the drive assembly and cutter element.

In a preferred embodiment the flexible drive member may include a drive belt and the drive unit may include a drive pulley for engaging and driving the drive belt. The float arm may include an elongate tube. The elongate tube may be generally rectangular in cross section and the belt may be disposed in the plane of the longer rectangular dimension. The float arm may include a tube mount for fastening the tube to the motor and drive unit. The cutter head may be integral with the float arm. The cutter head may be removable from the float arm. The drive assembly may include a driven pulley driven by the flexible drive member. The driven pulley may include a recess to nest a bearing at its lower end. The upper end of the driven pulley may include a drive plate for engaging the cutter element. The cutter head may include a cutter guard having a central opening to receive the cutter element. The cutter guard may include a recess to nest a top bearing at its lower end. The cutter guard may be sealingly engaged with the cutter head at its outer edge and press fit to the top bearing proximate the central opening to prevent grinding residue from entering the cutter head. The drive plate may extend through the cutter guard central opening to the cutter element and the cutter guard and cutter element may include alignment members to center the cutter element in the central opening and above the cutter guard for free rotation. The flexible drive member may include a chain. The flexible drive member may include a pulley belt. The pulley belt may be a synchronous drive belt and the drive unit and drive assembly may include synchronous pulleys. The drive unit and drive assembly axes of rotation may be generally parallel.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is an exploded, three dimensional assembly view of a tooth grinding system according to this invention;

FIG. 2 is an enlarged three dimensional view of a stock drive shaft modified for use in the system of FIG. 1;

FIG. 3 is a side sectional view of the drive shaft of FIG. 2;

FIG. 4 is an enlarged three dimensional view of the tube of FIG. 1;

FIG. 5 is a further enlarged side sectional view of the tube of FIG. 4;

FIG. 6 is an enlarged, three dimensional view of the cutter head of FIG. 1;

FIG. 7 is a sectional view of the cutter head of FIG. 6;

FIG. 8 is an enlarged, three dimensional view of the cutter head pulley and drive plate;

FIG. 9 is a sectional view of the cutter head pulley of FIG. 8;

FIG. 10 is a three dimensional view of the cutter guard 68 of FIG. 1;

FIG. 11 is a sectional view of the cutter guard 68 of FIG. 10;

FIG. 12 is a three dimensional top view of the cutter element of FIG. 1; and

FIG. 13 is a three dimensional bottom view of the cutter element of FIG. 1.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

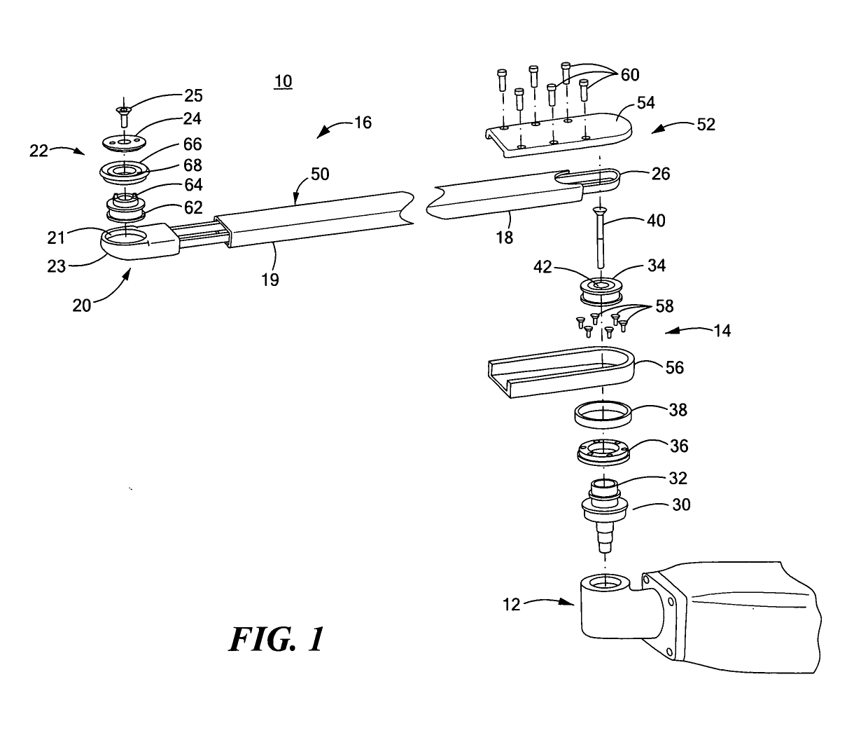

There is shown in FIG. 1 a tooth grinding system 10 according to this invention which includes an electric motor 12 such as a Makita right angle drive model DA3010F. There is a drive unit 14 driven by motor 12, float arm 16 attached, at its proximal end 18, to the electric motor 12. At the distal end 19 of arm 16 is a cutter head 20 including cutter element 22. Cutter head 20 includes a drive assembly 22 which drives cutter element 24 secured by screw 25. Drive unit 14 drives drive assembly 22 through belt 26 located in float arm 16. Drive unit 14 includes a stock drive shaft 30 whose upper portion 32 is modified to guide driven pulley 34 through tapped lock ring 36 and threaded spacer ring 38. A threaded screw 40 passes through central hole 42 in pulley 34 and engages threads within modified drive shaft 30. Float arm 16 includes a tube 50 and may include a tube mount 52 having a cover 54 and base 56. Base 56 is fixed to tapped lock ring 36 by means of screws 58, for example, and cover 54 is attached to base 56 by means of screws 60. Tube 50 may have a flattened cross section in order to minimize its size in the height direction and lessen the discomfort for the horse and allow it to be applied to teeth further back in the horse's mouth. Belt 26 drives driven pulley 62 in drive assembly 22 which in turns drives drive plate 64 which extends through the central opening 66 of cutter guard 68. Alignment means on the bottom of cutter element 24 and the top of drive plate 64 fix cutter element to rotate with drive plate 64 and driven pulley 62 as well as maintains a slight vertical spacing between cutter element 24 and cutter guard 68 to allow clearance for rotation. While belt 26 is shown as a synchronous belt with teeth accommodating similar teeth on driven pulley 62 and drive pulley 34, this is not a necessary limitation of the invention, for example, the pulleys may be plain pulleys and the belt may be a plain belt or the pulleys may be gears and the belt 26 may be a chain, all in keeping with the invention. Body 92 of cutter head 20 includes a hole 21 with threads 23 for receiving similar threads on cutter guard 68.

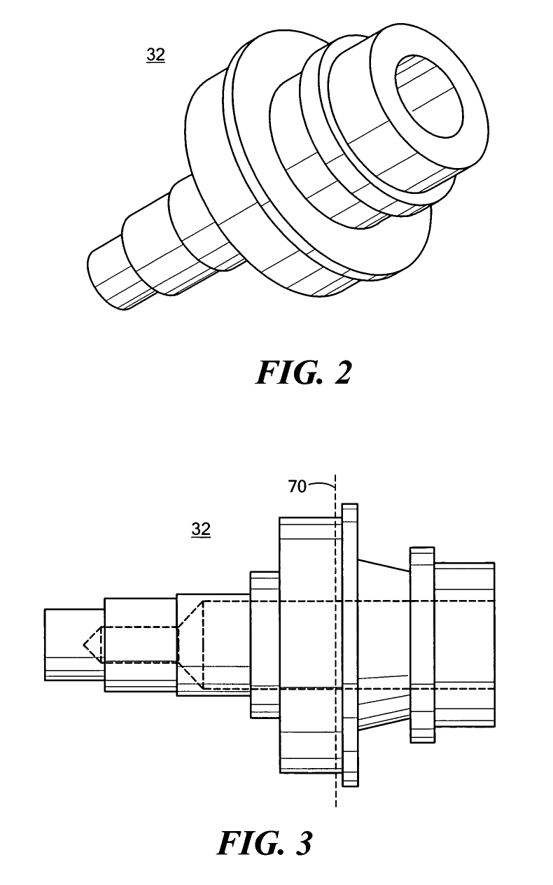

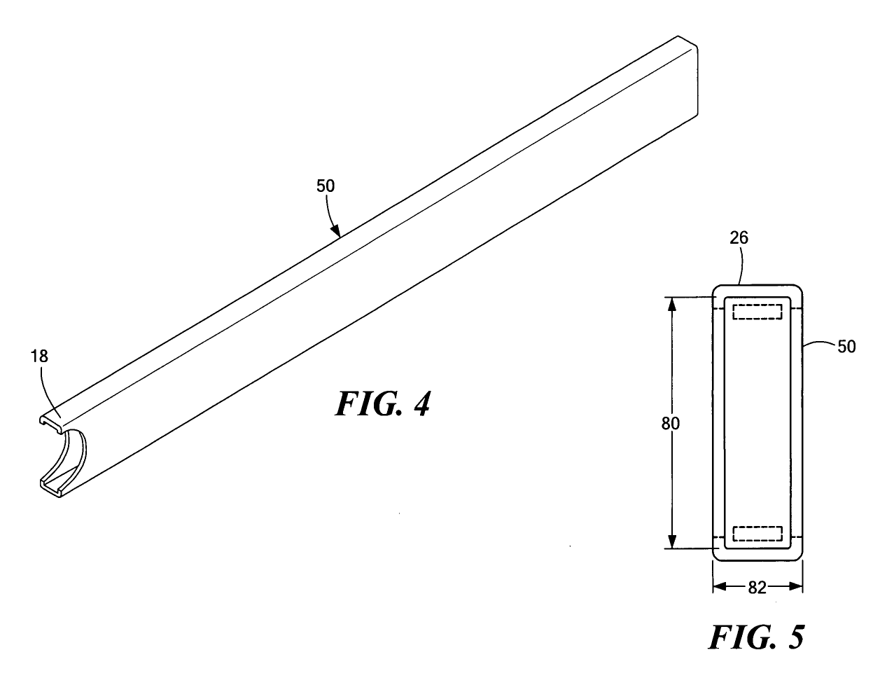

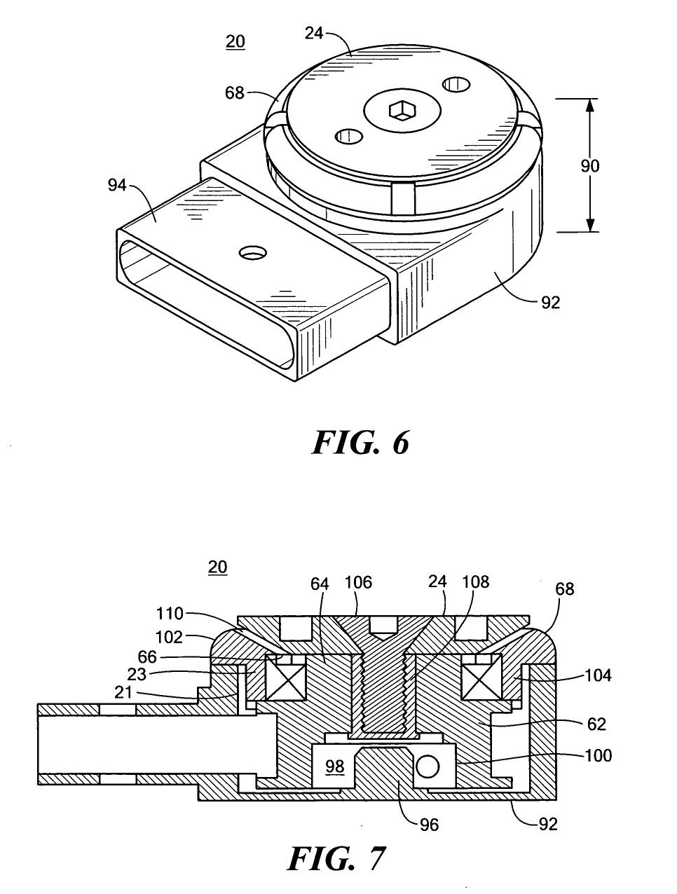

Modified stock drive shaft 32 is shown somewhat enlarged and in more detail in FIG. 2, and in side section in FIG. 3, where it can be seen that to the left of dotted line 70 remains unmodified, whereas the upper portion to the right of dotted line 70 is modified as shown to accommodate drive pulley 34. Tube 50 of float arm 16 is shown in greater detail in FIG. 4, and in cross section in FIG. 5, where the rectangular cross section is clearly visible showing that the longer dimension 80 in the plane of the belt 26 is much greater that the size of the shorter rectangular dimension 82, which is a critical one for clearance between the teeth in the horse's mouth. Cutter head 20, FIG. 6, is quite narrow in the height dimension 90 with only the cutter guard 68 and cutter element 24 extending above the cutter head body 92. The body 92 of cutter head 20 is shown as having a reduced extension 94 for insertion into the distal end 19 of tube 50 but this is not a necessary limitation of the invention, in fact in some embodiments it is preferred that the body 92 of cutter head 20 be permanently and integrally fastened with tube 50.

The relationship of the various parts of the cutter head 20 are shown in the sectional view of FIG. 7, where body 92 has a stud 96 rising from the bottom which engages the inner race of ball bearing 98. The outer race of ball bearing 98 is press fit with recess 100 of driven pulley 62. Nesting ball bearing 98 in recess 100 removes the height of ball bearing 98 from the height of the stack and so reduces the overall height of cutter head 20. Drive plate 64 rises from and integral with driven pulley 62 and is reduced at its top to receive the inner race of ball bearing 102. The outer race of ball bearing 102 nests within recess 104 of cutter guard 68. Nesting of ball bearing 102 in recess 104 once again contributes to reducing the overall height of cutter head 20 by eliminating the height of ball bearing 102 from the stack and folding it into cutter guard 68. A substantial advantage of the invention, the ability to service or replace the operative parts of cutter head 20, FIGS. 1, 9, can now be more readily understood. Screw 25 is removed releasing cutter element 24. The cutter guard 68 is unscrewed making easily accessible driven pulley 62, and integral drive plate 64 along with both bearings 98 and 102. With that, the entire drive assembly 22 is extracted and can be serviced or replaced.

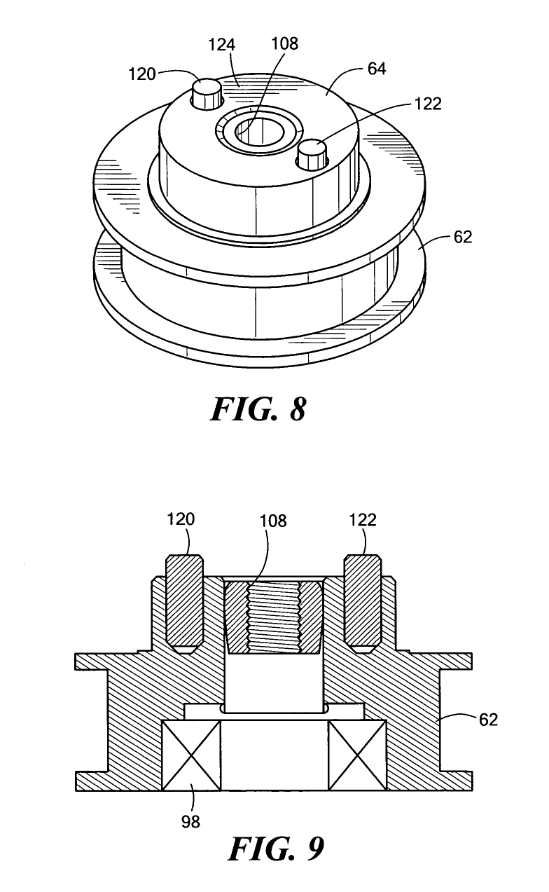

Cutter element 24 is fastened to pulley 62 and drive plate 64 by screw 106 which engages threaded bore 108 extending through drive plate 64 and driven pulley 62. A small gap 110 occurs between cutter element 24 and cutter guard 68 by means of alignment members on cutter element 24 and drive plate 64, as can be seen more readily in FIG. 8. There two upstanding pins 120, 122 are provided to force cutter element 24 to rotate with drive plate 64 and also through the cooperation of pins 120, 122 and the top surface 124 of drive plate 64 to create clearance gap 110 for rotational clearance of cutter element 24. A construction of pulley 62 and drive plate 64 is shown more clearly in the sectional view of FIG. 9 along with nested bearing 98 and threaded bore 108.

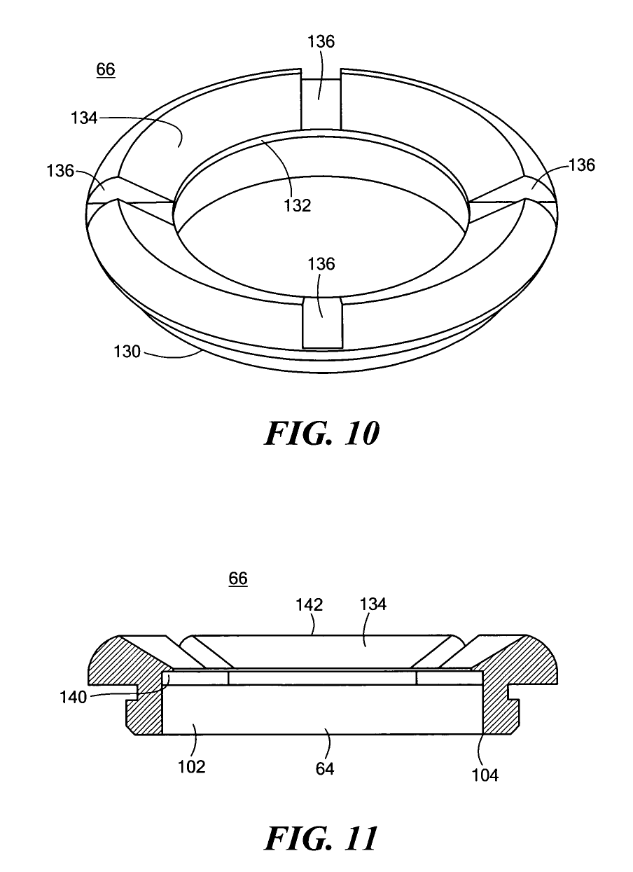

Cutter guard 68, FIG. 10, includes a lower portion 130 with threads 131 for engaging threads 23, FIG. 1, inside cutter head 20 body 92, FIG. 7. At its upper end there is a central hole 132, FIG. 10, with sloping sides 134 to accommodate cutter element 24. The four notches or keyways 136 are there merely for convenience to allow a wrench to be used to loosen and tighten cutter guard 66 in its threaded seat. Referring to FIG. 11 it can be seen that the configuration provides a seal to prevent grinding residue such as equine saliva and tooth grindings, to enter into the mechanism. This is accomplished by two means: the inner race of ball bearing 102 is press fit to drive plate 64 providing an excellent seal in that area; the outer race is overlapped by the lip 140 of cutter guard 68. This lip is formed by the inner edge 142 of the sloping surface 134 which just slightly overhangs the outer race of ball bearing 102. Thus when cutter guard 68 is screwed down tightly in cutter head 20 this lip 140 seals firmly against the outer race of ball bearing 102.

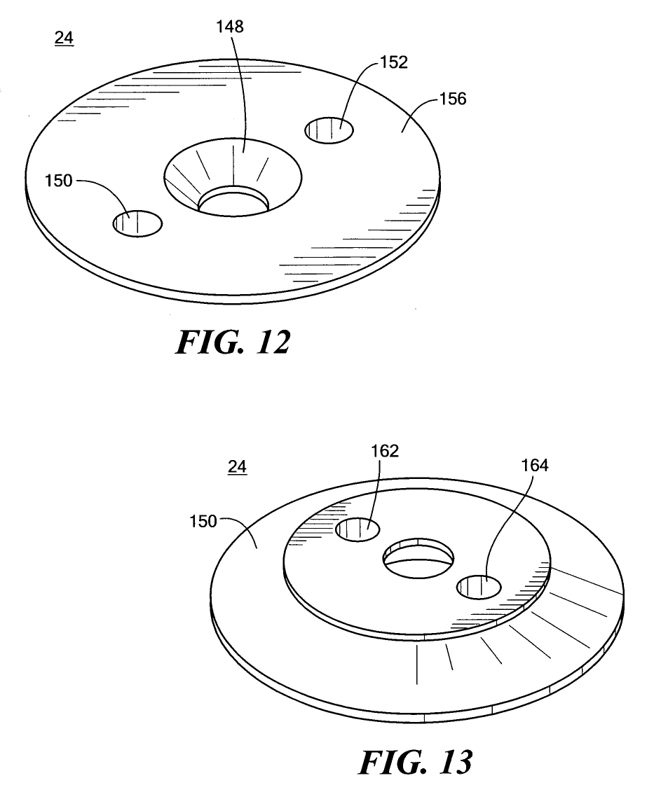

Cutter element 24, FIG. 12, is a disk with a conical hole in its center for accommodating screw 25 and a pair of holes 150, 152 for accommodating a spanner wrench. The surface is covered with a carborundum or diamond grit for improved grinding. The bottom side of cutter element 24, FIG. 13, shows a sloped edge 160 which matches the sloped sides 134 of cutter guard 68. Also shown are holes 162 and 164 which accommodate the pins of drive plate 64 shown in FIGS. 8 and 9. While the pins 120, 122 are on the drive plate and the accommodating holes 162, 164 are on the cutter element this is not a necessary limitation of the invention, the positions could be reversed or other means could be used to align and register the pieces.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A tooth grinding system comprising:
an electric motor;
a drive unit driven by said motor;
a float arm attached to said electric motor at one end;
a cutter head at the distal end of said arm including a drive assembly and a cutter element driven by said drive assembly; and
a flexible drive member within said arm and driven by said drive unit to drive said drive assembly and cutter element.

2. The tooth grinding system of claim 1 in which said flexible drive member includes a drive belt and said drive unit includes a drive pulley for engaging and driving said drive belt.

3. The tooth grinding system of claim 1 in which said float arm includes an elongate tube.

4. The tooth grinding system of claim 3 in which said elongate tube is generally rectangular in cross section and said belt is disposed in the plane of the longer rectangular dimension.

5. The tooth grinding system of claim 3 in which said float arm includes a tube mount for fastening said tube to said motor and drive unit.

6. The tooth grinding system of claim 1 in which said cutter head is integral with said float arm.

7. The tooth grinding system of claim 1 in which said cutter head is removable from said float arm.

8. The tooth grinding system of claim 1 in which said drive assembly includes a driven pulley driven by said flexible drive member.

9. The tooth grinding system of claim 8 in which said driven pulley includes a recess to nest a bearing at its lower end.

10. The tooth grinding system of claim 9 in which the upper end of said driven pulley includes a drive plate for engaging said cutter element.

11. The tooth grinding system of claim 10 in which said cutter head includes a cutter guard having a central opening to receive said cutter element.

12. The tooth grinding system of claim 11 in which said cutter guard includes a recess to nest a top bearing at its lower end.

13. The tooth grinding system of claim 12 in which said cutter guard is sealingly engaged with said cutter head at its outer edge and press fit to said top bearing proximate said central opening to prevent grinding residue from entering said cutter head.

14. The tooth grinding system of claim 11 in which said drive plate extends through said cutter guard central opening to said cutter element and said cutter guard and cutter element include alignment members to center said cutter element in said central opening and above the cutter guard for free rotation.

15. The tooth grinding system of claim 1 in which said flexible drive member is a chain.

16. The tooth grinding system of claim 1 in which said flexible drive member is a pulley belt.

17. The tooth grinding system of claim 16 in which said pulley belt is a synchronous drive belt and said drive unit and drive assembly include synchronous pulleys.

18. The tooth grinding system of claim 1 in which said drive unit and drive assembly axes of rotation are generally parallel.
